(19) United States
(12) Patent Application Publication
(10) Pub. No.: US 2021/0223557 A1
(43) Pub. Date: Jul. 22, 2021

(54) ACTIVE DISPLAY HELMET

(71) Applicant: Hypergiant Industries, Inc., Austin, TX (US)

(72) Inventors: Benjamin Edward Lamm, Dallas, TX (US); Andrew Thomas Busey, Austin, TX (US); Daniel David Haab, Austin, TX (US); Davis Michael Saltzgiver, Austin, TX (US); Marc Allen Boudria, Austin, TX (US)

(21) Appl. No.: 16/896,107

(22) Filed: Jun. 8, 2020

Related U.S. Application Data
(60) Provisional application No. 62/889,915, filed on Aug. 21, 2019.

(51) Int. Cl. G02B 27/01

(52) U.S. Cl. CPC G02B 27/0179; G02B 2027/0138; G02B 2027/0181; G02B 27/0172

(57) ABSTRACT

Systems and methods for providing an active display of a user's environment on a wearable element (e.g., a helmet) are disclosed. Displaying an active display may include displaying a head-up-display on a display screen on the wearable element that is positioned to cover the field of view of the user when the user wears the wearable element. The head-up display may include a display generated from images (e.g., video) captured by one or more image capture elements (e.g., cameras) coupled to the wearable element. In certain instances, the head-up-display replaces the field of view of the user while the wearable element is worn by the user. The head-up-display may also display data received from one or more sensors coupled to the wearable element and data received from another data source in wireless communication with the wearable element.

### PRIORITY CLAIM

The present applications claims priority to U.S. Provisional Appl. No. 62/889,915, filed Aug. 21, 2019, the disclosure of which is incorporated by referenced herein in its entirety.

### BACKGROUND

### 1. Field of the Invention

The present disclosure relates generally to devices for active display of a user's environment. More particularly, embodiments disclosed herein relate to devices wearable on a person's head, such as helmets, that are operable to provide a display to a user based on data from a sensor array and data received from external source.

### 2. Description of Related Art

Head-up displays (HUDs) are increasingly being developed for various uses. Current helmet or eye-wear mounted HUDs typically provide augmented reality displays that enable users to view reality with augmented information. For example, a HUD may provide additional information to a user's normal field of view to allow the user to more readily access the information without having to look elsewhere (e.g., on a handheld or wearable device). While HUDs that provide information in the user's normal vision are useful in certain situations, there are situations where additional information may be needed that such systems are not capable of displaying readily to the user. For example, it may be useful in dangerous situations such as those encountered by firefighters, police, security, military, search and rescue, etc. to have additional information readily available without the need to look outside the user's field of view for that information. Thus, there is a need for systems and methods that provide a large spectrum of information to the user in the field of view of the user. There is also a need for systems that are adaptable to a variety of situations for presenting such information and can provide the information in a selectable manner.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts a perspective view of an embodiment of a helmet.

FIG. 2 depicts a block diagram of an embodiment of a helmet.

FIG. 3 depicts a block diagram of an embodiment of a communication environment for a helmet.

FIG. 4 depicts a flowchart for an embodiment of a HUD display generation process using a helmet.

FIG. 5 depicts a representation of an embodiment of an optical-based (“day vision”) HUD.

FIG. 6 depicts a representation of an embodiment of an infrared HUD.

FIG. 7 depicts a representation of an embodiment of night vision HUD.

FIG. 8 depicts a representation of an embodiment of thermal image HUD.

FIG. 9 depicts a block diagram of an embodiment of an operational environment.

FIG. 10 is a flow diagram illustrating a method for displaying a head-up display, according to some embodiments.

FIG. 11 is a block diagram of one embodiment of a computer system.

FIG. 12 illustrates a block diagram of an exemplary embodiment of an operating environment.

FIG. 13 depicts an exemplary system for displaying data on a display.

FIG. 14 illustrates an embodiment of the process steps for displaying on-demand information on the heads-up display of a helmet.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Within this disclosure, different entities (which may variously be referred to as “units,” “mechanisms,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. A “controller configured to control a system” is intended to cover, for example, a controller that has circuitry that performs this function during operation, even if the controller in question is not currently being used (e.g., is not powered on). Thus, an entity described or recited as “configured to” perform some task refers to something physical, such as a device, circuit, memory storing program instructions executable to implement the task, etc. This phrase is not used herein to refer to something intangible.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” or “responsive to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

### DETAILED DESCRIPTION OF EMBODIMENTS

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

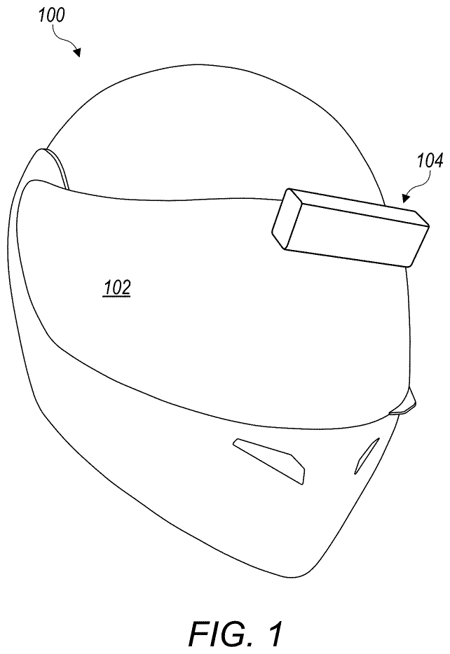

FIG. 1 depicts a perspective view of an embodiment of helmet 100. Helmet 100 may be a wearable element such as a device wearable on a head of a user. For example, helmet 100 may be a shell shaped to allow a user's head to be placed inside the helmet for wearing by the user. In some embodiments, helmet 100 is part of a wearable element (e.g., part of a clothing apparatus worn by user such as a space suit or a combat suit). In certain embodiments, helmet 100 includes two shells that encircle the wearer's head. The outer shell may be a hard, plastic material or another protective material depending on the use of helmet 100 (e.g., Kevlar®, carbon fiber, etc.). The inner shell may include protective foam or another shock absorbing material to provide comfort to the user. The outer and inner shells may help protect the wearer's head in case of impact, collision, or other environmental conditions (e.g., heat, light, etc.). The helmet may also contain one or more additional layers as needed to protect the wearer's head during impact or collision. In some embodiments, helmet 100 includes, as shown in FIG. 1, full-face coverage for the user (e.g., the helmet provides substantially full enclosure around the user's face and head). For example, helmet 100 may be have shape and design similar to a motorcycle helmet. It is to be understood that while embodiments described herein are applied to the use of a helmet to provide enhanced display to a user, additional embodiments using other types of devices wearable on a user's head may also be contemplated. For example, embodiments of helmet 100 described herein may be incorporated into embodiments of goggles or another head-wearable device worn by a user.

In certain embodiments, visor 102 is coupled to (e.g., attached to) helmet 100. In some embodiments, visor 102 is pivotally attached to helmet 100 to allow the visor to be raised and lowered from in front of the user's eyes. When lowered, visor 102 may be located on helmet 100 such that the visor is positioned in front of the user's eyes, as shown in FIG. 1. In some embodiments, visor 102 encompasses an entire field of vision of the user while the visor is positioned in front of the user's eyes. Visor 102 may include display component(s) (e.g., LCD screen(s)) and additional visual circuitry, as described herein, to provide a head-up display (HUD) to the wearer of the helmet. In some embodiments, visor 102 or helmet 100 includes eyeglasses or goggles that are used to provide the HUD to the wearer of the helmet.

In certain embodiments, sensor array 104 is coupled to (e.g., attached to) helmet 100. In some embodiments, sensor array 104 is coupled to visor 102. In some embodiments, sensor array 104 is incorporated into helmet 100 or a wearable element associated with the helmet (e.g., a suit that integrates the helmet). Sensor array 104 may be positioned on helmet 100, for example, at or near an upper center section of the helmet such that the sensor array is directed along a sight line of the wearer of the helmet. In certain embodiments, sensory array 104 includes one or more image capture elements (e.g., cameras or other elements capable of capturing still images and continuous video images at least one wavelength of light). Camera(s) or image capture element(s) that may be included in sensor array 104 include, but are not limited to, optical (visual or high resolution binocular optical) cameras, two-dimensional image cameras, three-dimensional image cameras, motion capture cameras, night vision cameras, FLIR (forward-looking infrared) cameras, thermal imaging cameras, and electromagnetic spectrum imaging cameras. In certain embodiments, sensor array 104 may include other environmental sensor elements including, but not limited to, proximity sensors, ranging sensors, GPS (global positioning system) sensors, magnetic detection sensors, radiation sensors, chemical sensors, temperature sensors, pressure sensors, humidity sensors, air quality sensors, object detection sensors, and combinations thereof. In some embodiments, sensory array 104 includes one or more biometric sensor elements including, but not limited to, vital sign measurement sensors, body motion sensors, and body position sensors.

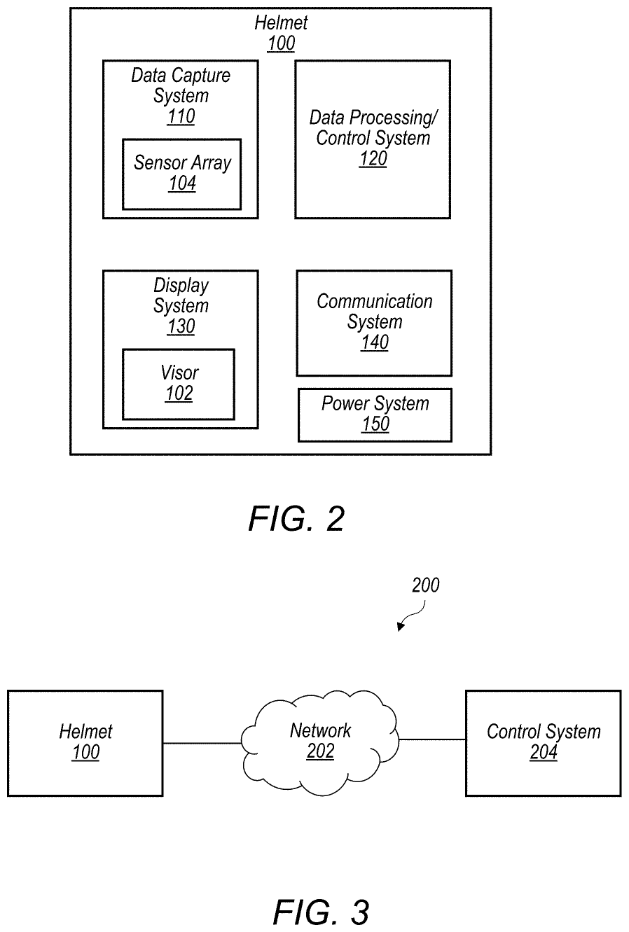

FIG. 2 depicts a block diagram of an embodiment of helmet 100. In certain embodiments, helmet 100 includes data capture system 110, data processing/control system 120, display system 130, communication system 140, and power system 150. Data capture system 110 may be coupled to and receive data from sensor array 104. For example, data capture system 110 may receive data from camera(s) and/or sensor(s) in sensor array 104. Data capture system 110 may receive data from sensor array 104 using wired, wireless communication, or a combination thereof. In some embodiments, data capture system 110 receives data through communication system 140.

Data capture system 110 may also be capable of receiving data from other systems associated with the wearer of helmet 100. For example, data capture system 110 may receive data from biometric sensors coupled to the user (e.g., vital sign sensors, body position sensors, or body motion sensors). Vital sign sensors may include, but not be limited to, heart rate sensors, respiration rate sensors, and blood oxygen saturation (SpO2) sensors. The biometric sensors may, for example, be located in clothing (e.g., a suit worn by the user) or otherwise coupled to or attached to the user's body. Data capture system 110 may receive data from the biometric sensors using either wired or wireless communication (e.g., through communication system 140). Data capture system 110 may also receive data from additional environmental sensors not located on helmet 100 (e.g., environmental information about clothing worn by the user such as pressure, temperature, humidity, etc.).

Data processing/control system 120 may process data from a variety of sources in helmet 100 and control or operate the various systems of the helmet. For example, data processing/control system 120 may process data from data capture system 110 and control operation of display system 130 using the processed data (such as provide commands for displaying processed data on the HUD display of visor 102). Data processing/control system 120 may be capable of receiving external data (data from communication system 140) and providing the data to systems (display system 130) within helmet 100. Data processing/control system 120 may further be capable of providing processed data to external/remote systems (such as a command or control system as described herein) using communication system 140.

Display system 130 may include or be coupled to visor 102. Display system 130 may be capable of receiving data from any of various systems in helmet 100 (e.g., data processing/control system 120) and operating to display the data on the HUD display of visor 102 or helmet 100. As mentioned above, visor 102 may include display component(s) to provide a HUD display to a wearer of helmet 100. The HUD display may be provided by any combination of display devices suitable for rendering textual, graphic, and iconic information in a format viewable by the user inside visor 102. Examples of display devices may include, but not be limited to, various light engine displays, organic electroluminescent display (OLED), and flat screen displays such as LCD (liquid crystal display) and TFT (thin film transistor) displays. In certain embodiments, the display device(s) are incorporated into visor 102. The display device(s) may also be attached to or otherwise coupled to visor 102. In some embodiments, the display device(s) include eyeglasses or goggles.

Power system 150 may include power supplies and other devices for providing power to the various systems in helmet 100. For example, power system 150 may include one or more batteries for providing power to helmet 100. The batteries may be, for example, rechargeable batteries that are charged using a charging port (e.g., USB charging port) or another connector type. In some embodiments, the batteries may be charged using solar panels in or on helmet 100 or any other suitable charging means. In some embodiments, power system 150 may include batteries or other power sources not located on helmet 100. For example, a battery or power source may be located in a pack (such as a battery pack) carried on a back of the user.

Communication system 140 may operate to provide communication capabilities between various systems in helmet 100 (e.g., between data capture system 110, data processing/control system 120, and display system 130) as well as provide communication between the helmet and external/remote systems (e.g., control system 204, described herein). Communication system 140 may utilize various wired and/or wireless communication protocols to provide communication within and external to helmet 100. Wireless communication protocols for communication system 140 may include protocols such as, but not limited to, Bluetooth, Wi-Fi, ANT+, LiFi, and SATCOM. In some embodiments, communication system 140 may include optical communication devices (e.g., line-of-sight communication devices). Optical communication devices may be implemented, for example, in sensor array 104 to provide line-of-sight communication between additional helmets deployed at a location or other communication stations.

FIG. 3 depicts a block diagram of an embodiment of communication environment 200 for helmet 100. Communication environment 200 may include helmet 100, network 202, and control system 204. Network 202 may be used to connect helmet 100 and control system 204 along with additional systems and computing devices described herein. In certain embodiments, network 202 is an intranet, an extranet, a virtual private network (VPN), a local area network (LAN), a wireless LAN (WLAN), a wide area network (WAN), a metropolitan area network (MAN), a portion of the Internet, or another suitable network. In some embodiments, network 202 may include a combination of two or more such networks.

Control system 204 may be a remotely or centrally located control system. For example, control system 204 may be a base control system, a mission control system, a strategic control system, a fire dispatch control system, or another operational control system. Control system 204 may be located at any location relative to the deployment location of helmet 100. For example, control system 204 may be located at a central facility responsible for control of an entire ecosystem of helmets. Alternatively, control system 204 may be located at a remote command center deployed at or near the deployment location of helmet 100 (e.g., a temporary command center).

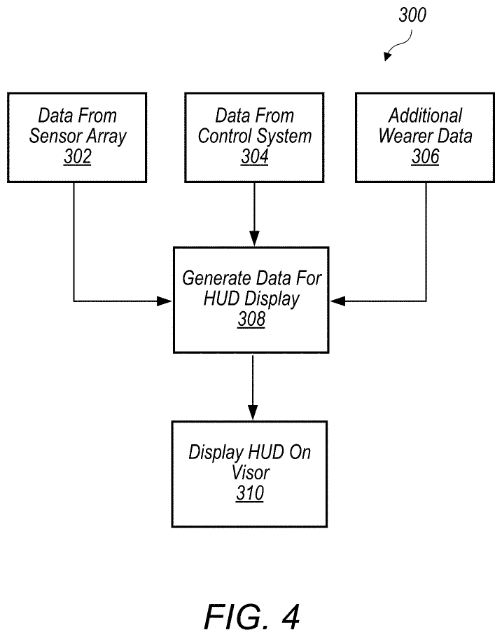

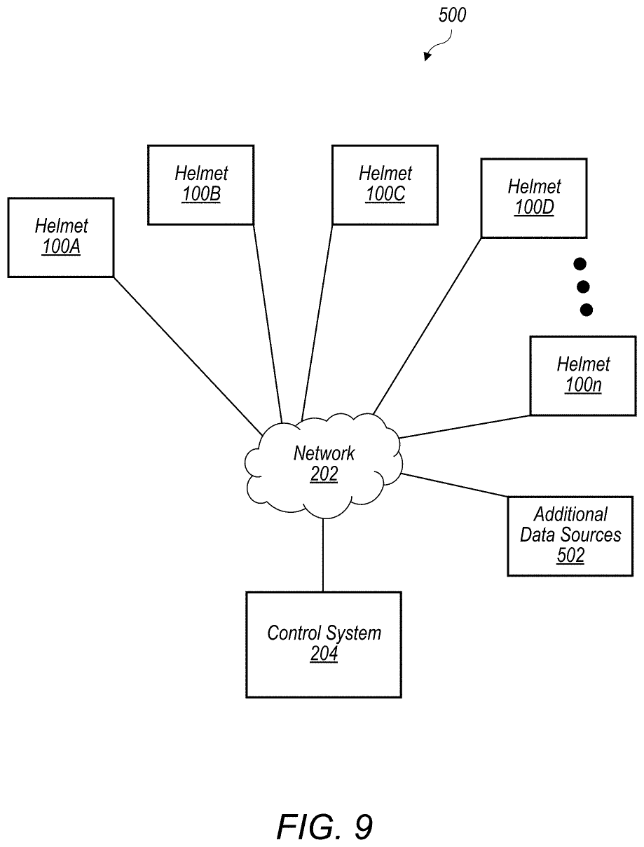

In certain embodiments, helmet 100, as described herein, is capable of collecting data related to the helmet wearer's environment (e.g., data from sensor array 104 or external data related to the environment received from control system 204), processing the data, and generating a display presented to the user on visor 102 (e.g., a HUD display for the user as described herein). FIG. 4 depicts a flowchart for an embodiment of HUD display generation process 300 using helmet 100. In process 300, data 302, data 304, and data 306 are combined to generate HUD display data in 308. Data 302 includes data from sensor array 104 (e.g., camera or sensor data from the sensor array). Data 304 includes data received from control system 204 (e.g., data collected from a variety of sources in an operational environment, as described in the embodiment of FIG. 9 below). Data 306 includes additional wearer data (e.g., data from additional biometric and/or environmental sensors coupled to the helmet wearer).

Generating data for HUD display in 308 may include processing of the input data to generate a representation of the wearer's environment for display on a HUD screen. In certain embodiments, data processing/control system 120 operates to generate the HUD display data in 308. In some embodiments, display system 130 generates the HUD display data in 308. Alternatively, data processing/control system 120 may generate the HUD display data in 308 in combination with display system 130.

In 310, the HUD display data generated in 308 may be provided to visor 102 (or another display) and displayed as HUD 400 (described below). In some embodiments, the HUD display data generated in 308 may be provided to another display element. For example, the HUD display data generated in 308 may be provided to control system 204 or an additional helmet worn by another user.

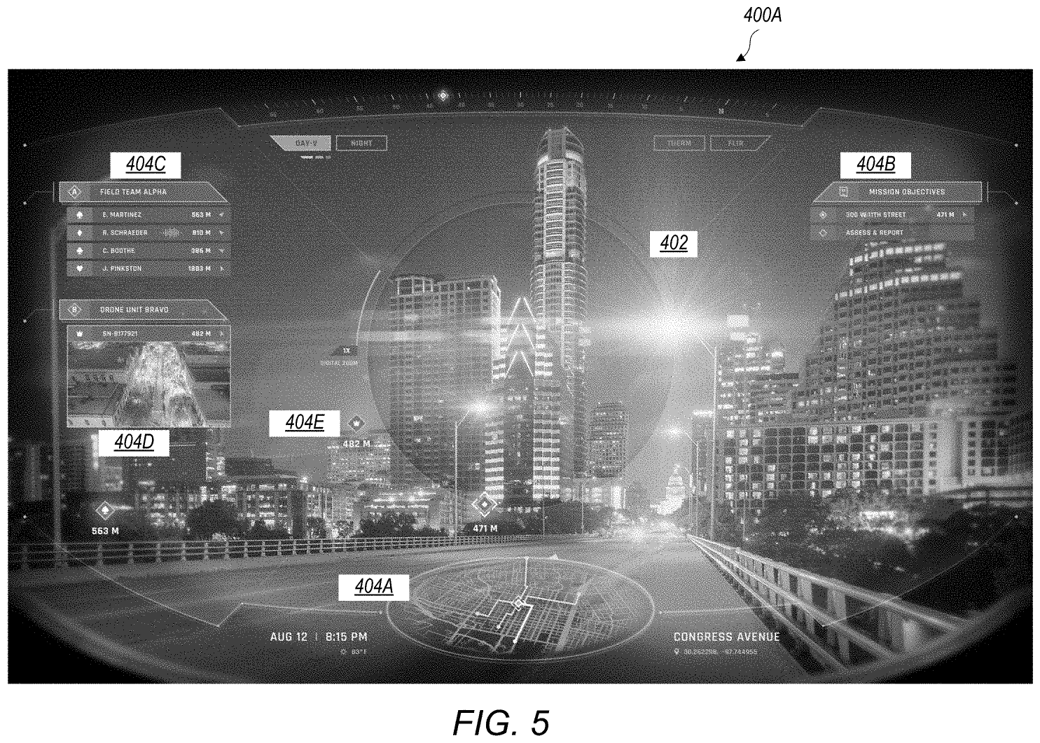

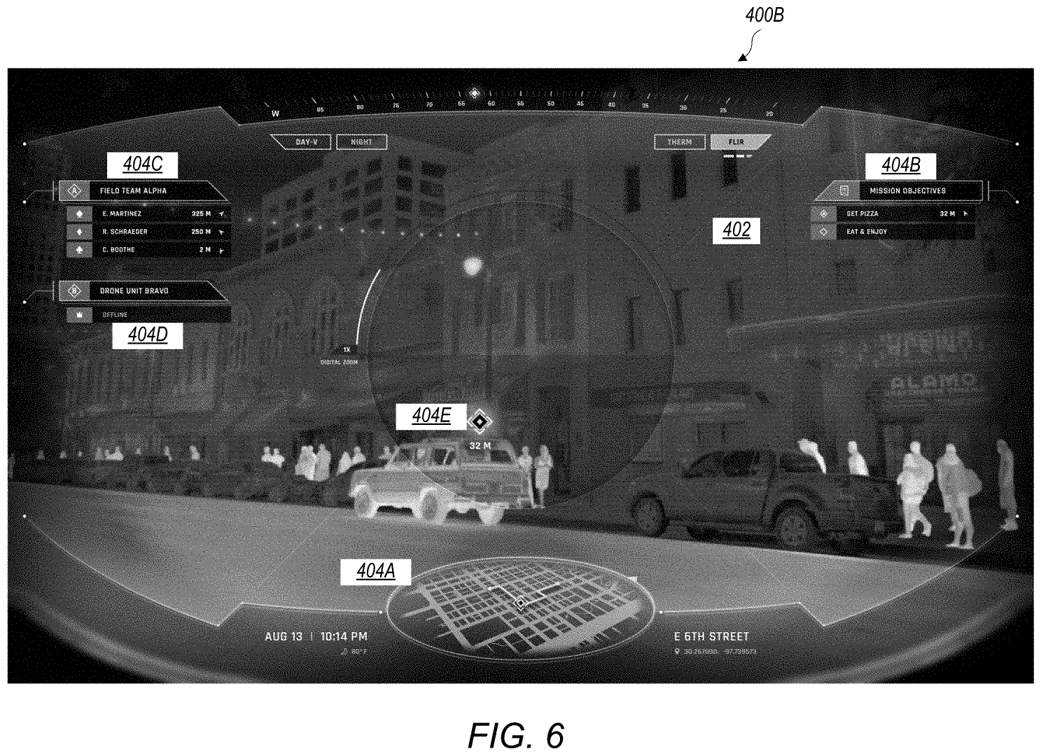

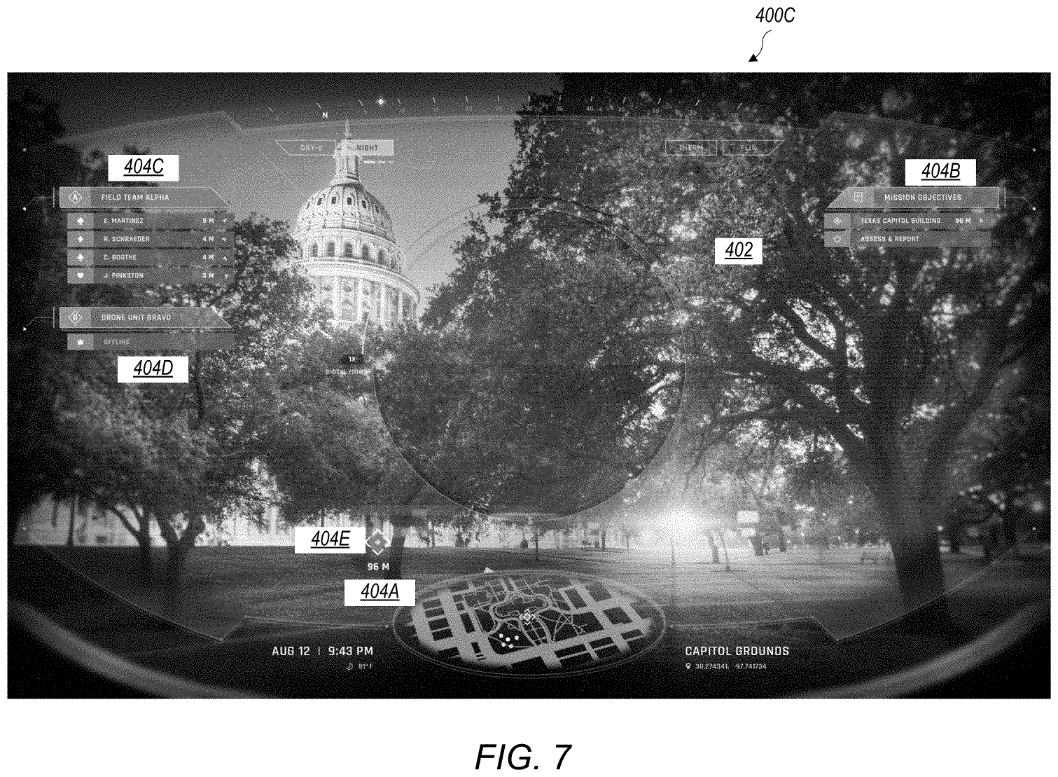

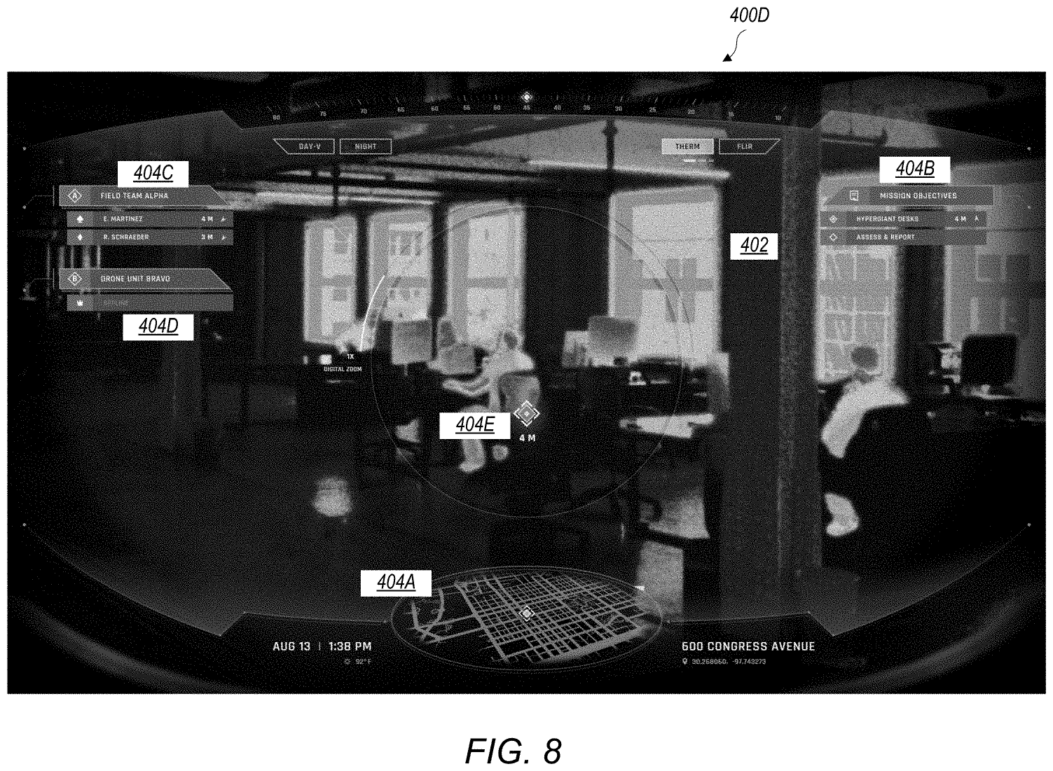

FIGS. 5-8 depict representations of possible embodiments of HUDs provided to a wearer of helmet 100. FIG. 5 depicts a representation of an embodiment of optical-based (“day vision”) HUD 400A provided to the wearer of helmet 100. HUD 400A may be provided using, for example, optical cameras in sensor array 104. The optical cameras may be visible spectrum or optical cameras (e.g., high resolution binocular optical input cameras). FIG. 6 depicts a representation of an embodiment of an infrared HUD 400B provided to the wearer of helmet 100. HUD 400B may be provided using, for example, FLIR cameras in sensor array 104. FIG. 7 depicts a representation of an embodiment of night vision HUD 400C provided to the wearer of helmet 100. HUD 400C may be provided using, for example, night vision cameras in sensor array 104. FIG. 8 depicts a representation of an embodiment of thermal image HUD 400D provided to the wearer of helmet 100. HUD 400D may be provided using, for example, thermal imaging cameras in sensor array 104.

As shown in FIGS. 5-8, HUDS 400A-D include scene representations 402. Scene representations 402 may be views of the helmet wearer's external environment that correspond to and replace the normal vision of the wearer. For example, scene representations 402 may be representative presentations of the scene in the user field of view generated based on image data from sensor array 104. Thus, scene representation 402 in HUD 400 on helmet 100 displays a view of the helmet wearer's external environment that replaces the wearer's vision of the external environment. As such, the helmet provides the wearer an active replacement representation of the world around the wearer based on data processed by the helmet (e.g., data from sensor array 104 and external data from control system 204) rather than the wearer's own view of the space around the wearer.

In some embodiments, HUD 400 displays scene representation 402 with high resolution (e.g., up to 5 k resolution) and with a large field of view (e.g., up to about a 200° field of view). In some embodiments, a portion of scene representation 402 may be digitally enhanced. For example, a digital zoom may be applied to a portion of scene representation 402 as selected by the helmet wearer using an input selection method described herein.

In certain embodiments, HUDS 400A-D are augmented/enhanced with additional information 404. Additional information 404 may be overlaid on scene representations 402, as shown in FIGS. 5-8. Additional information 404 provided in HUD 400 may vary based on the desired use of the helmet (e.g., firefighter, military, search and rescue, etc.). Additional information 404 may include, but not be limited to, data from other sensors in sensor array 104, external data received from control system 204 (e.g., data received via network 202 and communications system 140), and/or other data received from additional sensors on the wearer (e.g., additional biometric and environmental sensors on the wearer's body).

Non-limiting examples of additional information 404 include map data 404A, mission objective information 404B, team data 404C, additional image data 404D, and object identification 404E. Time, date, and heading information may also be displayed, as shown in FIGS. 5-8. Image selection may also be indicated in HUD 400. For example, selection of daytime vision image (“DAY-V”), night vision image (“NIGHT”), thermal image (“THERM”), infrared image (“FLIR”) may be shown in HUD 400.

Map data 404A may include, but not be limited to, a map of an area surrounding helmet 100 showing the helmet's location, a wayfinding route (e.g., route based on GPS wayfinding), locations of interest (e.g., goals or objects), and locations of other personnel (e.g., other mission or group personnel related to helmet wearer). For interior locations, map data 404A may include building blueprints showing location according to the blueprint rather than mapping location. Map data 404A may be based on data received from sensor array 104 (e.g., a GPS in the sensor array) and data received from control system 204.

Mission objective information 404B may be, for example, information about mission objectives or other objectives for the helmet wearer. Mission objective information 404B may be, for example, a checklist of objectives for the helmet wearer to accomplish. As objectives are achieved, the items may be checked off in the mission objective information 404B. Other information regarding mission objectives may also be displayed in mission objective information (e.g., identity of subjects for interaction, distance to objectives, etc.). In certain embodiments, mission objective information 404B to be displayed is included in data received from control system 204. In some embodiments, mission objective information 404B may include task updates provided by control system 204 (e.g., updated mission objectives based on changes in mission status).

Team data 404C may include, for example, information regarding other members of a team related to the helmet wearer (e.g., members of a firefighting team, a security team, a military group, a search and rescue team, etc.). Team data 404C may include data such as, but not limited to, team name, names of team members, status of team members, distance of team members, technical information for team members, location of team members, and combinations thereof. Team data 404C may be included in data received from control system 204. For example, team data 404C may be data received from additional helmets at control system 204 (as described herein).

Additional image data 404D may include additional images from external sources that are relevant to the helmet wearer. For example, as shown in FIG. 5, additional image data 404D may include an image from a drone showing an area around the helmet wearer. Additional image data 404D may be received from control system 204. Examples of other sources of additional image data 404D include, but are not limited to, other helmets, security cameras, satellite imagery, and radar imagery.

Object identification 404E may include identifying objects in the field of view of the helmet wearer. Data such as distance to object may be provided along with the object identification. In certain embodiments, object identification 404E includes identifying objects that are associated with the helmet wearer's mission objective(s). As shown in FIGS. 5-8, multiple object identifications may be presented in HUD 400. In some embodiments, the helmet wearer may select objects for identification (e.g., using gesture control to select an object in the wearer's field of view).

In certain embodiments, object identification 404E includes shape and/or object classification and detection in addition to masking and/or highlighting of objects. In some embodiments, object identification 404E is accomplished using an R-CNN (region-convolutional neural network). For example, an R-CNN may be trained and operated to detect and identify objects in a variety of scenarios associated with helmet 100. In some embodiments, object identification 404E may include contextual awareness of objects. For example, an object in HUD 400 can be identified to have been moved, added, or removed compared to a previous display of the same scene (e.g., something is different compared to a prior scene capture).

Examples of other information that may be displayed in HUD 400 include, but are not limited to, RAD levels for radiation, chemical levels, air quality levels, vital signs (of the wearer or other team members), GPS data, temperature data, and pressure data. In some embodiments, HUD 400 may display a point cloud mesh for areas known or identified in the display.

While the embodiments of HUD 400 depicted in FIGS. 5-8 display forward looking views for the helmet wearer (e.g., a normal field of view scene representation for the wearer), other views may also be displayed, as desired in HUD 400. For example, HUD 400 may display a rear view mirror display, a backwards view (e.g., representation if the wearer was to turn head around), a 360° view (or some view larger than the wearer's typical field of view), an overhead view (e.g., a view from an overhead drone), the view from another helmet (e.g., the view from a team member's helmet), or combinations thereof. In some embodiments, one or more alternative views may be shown as additional image data 404D, described above, on the normal field of view scene representation for the wearer.

In certain embodiments, data/information displayed in HUD 400 in helmet 100 is selectively controlled (e.g., switched) by the helmet wearer (e.g. the user). For example, the user may select or control an image type or mode for display in HUD 400 (e.g., select between daytime image mode (“DAY-V”), night vision image (“NIGHT”), thermal image mode (“THERM”), infrared image mode (“FLIR”) as depicted in HUDs 400A-D) or may select or control additional information 404 displayed in the HUD. The user may also select or control which sensors in sensor array 104 are turned on/off.

Various methods for control and selection of data for display (e.g., switching data for display) in HUD 400 in helmet 100 by the user are contemplated. For example, in some embodiments, control and selection of data for display in HUD 400 may be through voice control. In some embodiments, control and selection of data for display in HUD 400 may be operated using a user input device (e.g., wrist-based controls, touchscreen control, or keypad controls). The user input device may be integrated into helmet 100 or another device worn by the user (e.g., clothing or a wearable device). In some embodiments, gesture control may be used for control and selection of data for display in HUD 400. For example, helmet 100 may be programmed to recognize certain gestures by the user's hand to control and select operations of the helmet. Appendix A provides an example of a gesture control system for use with a helmet-based HUD display system. Additional examples of gesture control systems are described in U.S. patent application Ser. No. 16/748,469, which is incorporated by reference as if fully set forth herein.

In some embodiments, control and selection of data for display in HUD 400 in helmet 100 by the user allows the user to add/remove data from the vision of the user as needed or desired based on the current activity of the user. For example, the user may add building data for display in HUD 400 when entering a building or remove the building data when exiting the building. Allowing the user to control the selection of data displayed in HUD 400 may allow the user to efficiently operate by limiting their vision to necessary information for the immediate task.

In some embodiments, control system 204 controls the addition/removal of data displayed in HUD 400. For example, control system 204 may automatically add/remove the building data based on entry/exit of the user from the building. In some embodiments, addition/removal of data is automatically operated for HUD 400. For example, a warning light may be automatically displayed in HUD 400 when some warning threshold is exceeded (e.g., temperature warning or vital sign warning). The warning may be removed when the warning threshold is no longer exceeded.

As described herein, helmet 100 is capable of displaying many variations of selectable data that is obtained both from the helmet itself and from other sources. Data from other sources may include data from other sensors coupled to the helmet wearer's body as well as external/remote sources of data (e.g., other helmets, remote camera systems, remote sensor systems, etc.). Helmet 100 may operate in communication environment 200 (described above) to receive data (such as external/remote source data) from control system 204 as well as to send data to the control system. In certain embodiments, control system 204 is associated with an operational environment that incorporates a plurality of helmets 100 as well as additional data sources (e.g., databases, additional camera sources, or additional sensor sources).

FIG. 9 depicts a block diagram of an embodiment of an operational environment 500 for control system 204 and a multitude of helmets 100. Operational environment 500 may operate to provide interconnected operation and control of any number of helmets 100 (e.g., helmets 100A-100n). For example, operational environment 500 may provide interconnected operation for a security team, a firefighting team, a search and rescue team, a military team, or any group desiring situational coordination between multiple helmet wearers.

As shown in FIG. 9, helmets 100A-100n may be interconnected to control system 204 by network 202. Control system 204 may also be interconnected to one or more additional data sources 502. Additional data sources 502 may include, but not be limited to, databases of information (e.g., maps, building blueprints, etc.), downloadable/searchable information regarding mission objectives, data from additional camera sources (e.g., building security cameras), data from additional sensor sources (e.g., weather sensors, building environmental or structural sensors, etc.), and other information that may be useful for a particular operational environment.

Interconnection of control system 204 with helmets 100A-100n and additional data sources 502 may allow the control system to aggregate data from a variety of data sources (e.g., the helmets and the additional data sources) and provide the aggregated data to users (e.g., helmets) within the operational environment based on needs or selections of the user (as described herein). Thus, control system 204 may aggregate the data and provide the aggregated data to helmets 100A-100n to provide real-time operational support for individuals wearing the helmets. For example, real-time updates of helmet wearer data in operational environment 500 along with command information (e.g., mission control data) can be readily shared through the displays in helmets 100A-100n to allow more precise coordination in movements and/or actions of helmet wearers in the operational environment. Thus, helmet wearers in operational environment 500 may be able to accomplish their tasks and goals more quickly and more safely.

In some embodiments, helmet wearers are able to select data displayed as needed for operational environment 500 (e.g., control and select data displayed as described above). In some embodiments, control system 204 may determine the data that is displayed to individual helmets in operational environment 500. For example, control system 204 may determine that a set of data is displayed to all the helmets in operational environment 500 or only a selected set of helmets in the operational environment.

As described above, helmet 100 may receive and display data obtained from multiple sources (e.g., obtained both from the helmet itself and from other sources such as control system 204). In some embodiments, multiple types of information/data may be combined to provide specific displays in HUD 400 that may be useful for certain usage situations. Non-limiting examples of specific usage situations for helmet 100 are described below.

FIREFIGHTER EXAMPLE—For firefighter applications, it may be useful for a firefighter to have infrared/thermal vision integrated in HUD display in helmet 100 to show where a fire is or that a wall or object is hot. In some cases, structure information (e.g., blueprints, building layout, building point cloud mesh, etc.) may also be directly displayed in the firefighter's vision. Displaying structure information along with infrared/thermal vision input directly in the firefighter's vision may allow the firefighter to more safely navigate the structure in attempting to put the fire out and rescue people in the structure. Another operation that may be useful is the firefighter may access building security cameras (if operational) before or during the firefighting operation.

STRATEGIC/MILITARY EXAMPLE—For strategic/military applications, it may be useful for a user to stop and look at a 3-dimensional version of a building or structure before entering the building or structure. The user may also be able to access other user's vision for a short time or security cameras to assess the current situation before proceeding to another location. Additionally, providing an active display of other team member's locations may prevent accidental conflict between team members.

UNDERSEA EXAMPLE—It may be useful in undersea applications for helmet 100 to be able to detect and identify undersea cables or other structures. Helmet 100 may be used for welding applications to filter out unwanted visual noise while welding. Helmet 100 may also be useful in detecting and identifying objects during salvage operations.

SEARCH AND RESCUE EXAMPLE—Helmet 100 may be useful during search and rescue operations by being able to detect and identify objects using thermal or infrared detection in difficult situations such as avalanche scenarios or heavily forested areas.

INVESTIGATIVE EXAMPLE—In an investigative situation, it may be useful for helmet 100 to be used to detect heat signatures on objects (e.g., objects that have recently been touched). It may also be useful to able to detect other visual things using sensor array 104 in combination with movement of the user's hand in the field of view of the user.

### Example Methods

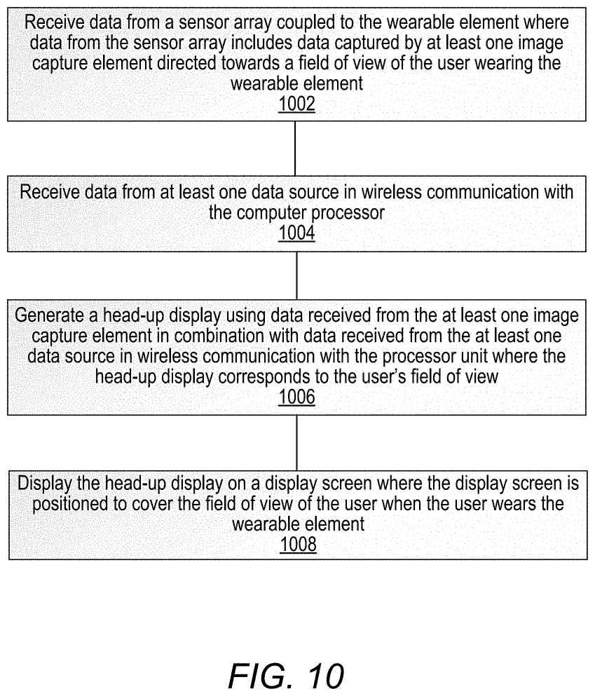

FIG. 10 is a flow diagram illustrating a method for displaying a head-up display, according to some embodiments. The method shown in FIG. 10 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 1002, in the illustrated embodiment, a computer processor coupled to a wearable element worn by a user receives data from a sensor array coupled to the wearable element where data from the sensor array includes data captured by at least one image capture element directed towards a field of view of the user wearing the wearable element.

At 1004, in the illustrated embodiment, the computer processor receives data from at least one data source in wireless communication with the computer processor.

At 1006, in the illustrated embodiment, the computer processor generates a head-up display using data received from the at least one image capture element in combination with data received from the at least one data source in wireless communication with the processor unit where the head-up display corresponds to the user's field of view.

At 1008, in the illustrated embodiment, the head-up display is displayed on a display screen where the display screen is positioned to cover the field of view of the user when the user wears the wearable element.

### Example Computer System

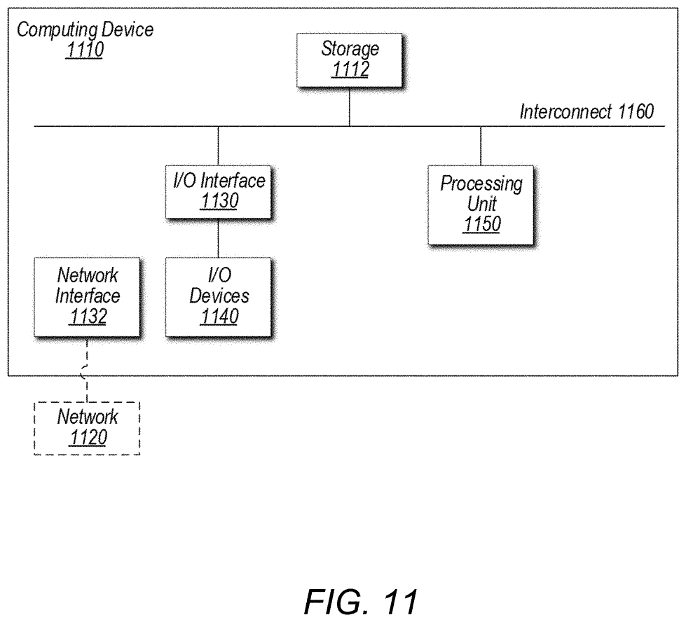

Turning now to FIG. 11, a block diagram of one embodiment of computing device (which may also be referred to as a computing system) 1110 is depicted. Computing device 1110 may be used to implement various portions of this disclosure. Computing device 1110 may be any suitable type of device, including, but not limited to, a personal computer system, desktop computer, laptop or notebook computer, mainframe computer system, web server, workstation, or network computer. As shown, computing device 1110 includes processing unit 1150, storage subsystem 1112, and input/output (I/O) interface 1130 coupled via an interconnect 1160 (e.g., a system bus). I/O interface 1130 may be coupled to one or more I/O devices 1140. Computing device 1110 further includes network interface 1132, which may be coupled to network 1120 for communications with, for example, other computing devices.

In various embodiments, processing unit 1150 includes one or more processors. In some embodiments, processing unit 1150 includes one or more coprocessor units. In some embodiments, multiple instances of processing unit 1150 may be coupled to interconnect 1160. Processing unit 1150 (or each processor within 1150) may contain a cache or other form of on-board memory. In some embodiments, processing unit 1150 may be implemented as a general-purpose processing unit, and in other embodiments it may be implemented as a special purpose processing unit (e.g., an ASIC). In general, computing device 1110 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage subsystem 1112 is usable by processing unit 1150 (e.g., to store instructions executable by and data used by processing unit 1150). Storage subsystem 1112 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 1112 may consist solely of volatile memory, in one embodiment. Storage subsystem 1112 may store program instructions executable by computing device 1110 using processing unit 1150, including program instructions executable to cause computing device 1110 to implement the various techniques disclosed herein.

I/O interface 1130 may represent one or more interfaces and may be any of various types of interfaces configured to couple to and communicate with other devices, according to various embodiments. In one embodiment, I/O interface 1130 is a bridge chip from a front-side to one or more back-side buses. I/O interface 1130 may be coupled to one or more I/O devices 1140 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### APPENDIX A

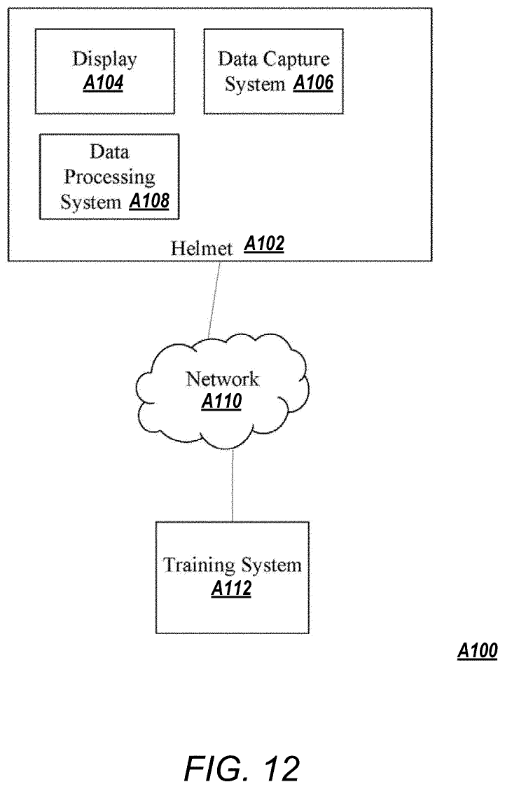

FIG. 12 illustrates a block diagram of an exemplary embodiment of an operating environment A100, which may be comprised of a training system A112, a network A110, and a helmet A102, which may be further comprised of a display A104, image capture system A106, and a data processing system A108.

A helmet A102 suitable for use in space is provided. The helmet A102 may be comprised of a display A104, a data capture device A106, and a data processing system A108, which may be mounted to the helmet. The helmet provides a pressurized oxygen-rich atmospheric bubble to protect the astronaut's head. It may be further comprised of a transparent portion or a semi-transparent portion that permits the astronaut to look outside of the helmet. The transparent or semi-transparent portion may also reduce certain wavelengths of light produced by glare or reflection from entering the astronaut's eyes.

It will be appreciated that the display A104 may be implemented using any one of numerous known display devices suitable for rendering textual, graphic, and/or iconic information in a format viewable by the user. Non-limiting examples of such display devices include various light engine displays, organic electroluminescent display (OLED), and flat screen displays such as LCD (liquid crystal display) and TFT (thin film transistor) displays. The display 1004 may additionally be secured or coupled to the housing or to the helmet by any one of numerous known technologies.

The data capture system A106 may capture data near or proximate to the astronaut. The data capture system A106 may be disposed on the helmet A102, and may be comprised of a two-dimensional image and/or motion capture camera, an infrared (IR) camera, a thermal imaging camera (TIC), a three-dimensional image and/or motion capture system, etc. The data capture system A106 may be configured to provide information to the display A104 via a wired or wireless connection (e.g. communicatively coupled to the display A104). The data processing system A108 may comprise a wireless communication module configured to provide communication between the display A104 and other devices, such as the image capture system A106 (e.g. such that the communicative coupling between the display A104 and the image capture system A106 may be through the data processing system A108), or any other device carried or worn by the user.

The data processing system A108 may be implemented or realized with at least one general purpose processor device, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. As described in more detail below, the processor is configured to drive the display functions of the display device A104, and is in communication with various electronic systems included in a space suit.

The data processing system A108 may include or cooperate with an appropriate amount of memory (not shown), which can be realized as RAM memory, flash memory, EPROM memory, EEPROM memory, registers, a hard disk, a removable disk, a CD-ROM, or any other form of storage medium known in the art. In this regard, the memory can be coupled to the processor module such that the processor module can read information from, and write information to, the memory. In the alternative, the memory may be integral to the processor module. In practice, a functional or logical module/component of the system described here might be realized using program code that is maintained in the memory. Moreover, the memory can be used to store data utilized to support the operation of the system, as will become apparent from the following description.

No matter how the data processing system A108 is specifically implemented, it is in operable communication with display device. The data processing system A108 is configured, in response to inputs from various sources of data such as space suit status sensors and environmental sensors (sensing, for example, suit pressure, temperature, voltage, current and the like), to selectively retrieve and process data from the one or more sources and to generate associated display commands. In response, display A104 selectively renders various types of textual, graphic, and iconic information that may be two or three dimensional, and may include three dimensional moving images. For simplifying purposes, the various textual, graphic, and iconic data generated by the display device may be referred to herein as an “image.”

In some embodiments, the image capture system A106 may be equipped with gesture sensing, wherein the sensed gestures may control the display A104 (for example, allowing the user to switch/scroll between different devices/equipment using gestures (e.g. a first gesture) or to select one of the several devices/equipment for display (e.g. display of that selected device's information) on the display A104 using gestures (for example using a second gesture). In some embodiments, the image capture system A106, the data processing system A108, and the display A104 may work together for gesture control (e.g. as part of a system). For example, the image capture system A106 may detect the astronaut's hand in motion, the data processing system A108 may analyze the data from the image capture system A106 to determine if detected hand motion/gestures match a predefined gesture indicative of a pre-set control, and the display A104 may operate in accordance with the control (e.g. when a match occurs/is detected).

In one embodiment, the data processing system A108 matches an astronaut's gestures to data provided by the training system A112. The training system A112 trains a classifier based on a variety of inputs, including but not limited to images, animated images, videos, three-dimensional/depth data, etc. In one embodiment, the training system A112 translates hand/motion data into a three-dimensional space and generates a skeletal frame, which may be imposed on an astronaut's hand or arm, and identifies pivot points to determine a specific orientation or gesture that may be made by the arm or the hand.

In one embodiment, the training system A112 and the image capture system A106 use two-dimensional data to respectively learn and identify gestures. As described above, it is generally easier to impose or translate a skeletal model over data obtained from multiple cameras or depth sensing cameras. In contrast, in accordance with an embodiment, the system learns and determines the presence of a gesture based on two-dimensional images. More specifically, the training system A112 determines whether a hand/arm is present, whether the hand/arm is in one of several predefined orientations based on training data. This embodiment is non-obvious for a variety of reasons, some of which are discussed here. For example, it is computationally inefficient to identify and train for gestures based on two-dimensional data. Generally, it is computationally more efficient to generate models based on three-dimensional data—as such the arc of the technology is away from a single camera system. However, it is much more energy efficient, and easier to control thermal ranges via a single camera system.

In one embodiment, the training system A112 uses a machine learning or artificial intelligence (AI) based classifier for determining whether the data captured by the image capture system A106 is a trained gesture. As describe herein, once a trained gesture is detected, the system may process additional data to display to the astronaut on his or her heads-up display unity. In one embodiment, AI classifier of the training system A112 uses an augmented dataset of various hand positions, orientations, and corresponding masks for efficient image processing and hand position/orientation detection. In one embodiment, a neural network may be used to identify desired gestures and develop a model for identifying desired gestures. The model may thereafter by applied by the data processing system A108 to determine if an astronaut has used a desired and a trained gesture.

More specifically, the training system A112 creates a generalized performance profile for various logical groupings. The training system A112 comprises a machine learning component that receives the performance profiles as training data and maximizes the ability of the system to produce high confidence gesture recognition while minimizing the required resources. Once training system A112 produces a machine learning model, the system can use that model to classify, in real time, input data from an image capture system A106 to dynamically determine if a trained gesture is performed by an astronaut.

In one embodiment, the training system A112 comprises logical grouping component, learning controller and analyzer, logical grouping machine learning system, and algorithm execution broker. Logical grouping component breaks the training data into groupings based on computer vision analysis and masks that may be applied to the training data.

In a training phase, the QA system receives training data with associated context and predetermined logical groupings and uses algorithms to find gestures based on the training data. In the training phase, learning controller and analyzer receives the logical groupings, the algorithms run as part of the pipeline, and their output values, and how much influence the outputs of the algorithms contributed to the final determination. Learning controller and analyzer keeps track of the system resource performance. For example, learning controller and analyzer may record how long an algorithm runs and how much heap/memory is used by each algorithm. Learning controller and analyzer receives the output information, algorithm, time taken, system resources, and number of input data items to the algorithm and creates a performance profile for that algorithm and logical grouping.

The performance characteristics used in metrics include heap sizes, CPU utilization, memory usage, the execution time of an algorithm, file input and output access and write speeds. Typical performance characteristics in a computing environment include the number of features produced by the algorithm and the number of data structures of a specific type that is currently loaded in memory. The correctness metrics include how many features for each algorithm were produced for that logical grouping and how those features for that logical grouping impact the overall result or the algorithm itself. Finally, correctness metrics take into account, when a final answer is given, whether that answer is correct and how the features and algorithms affected the answer by weight.

In accordance with one example embodiment, the algorithms may be modified or enhanced to output the data it operates on and what inputs contributed to its output. Some algorithms may use as input data that is provided as output by another algorithm. These algorithms may be used in various combinations and these combinations may contribute to the answer to varying degrees.

In the training phase, logical grouping machine learning system receives the performance profiles as training data. Logical grouping machine learning system receives as input the logical groupings, image context, and results of the answers. Logical grouping machine learning system makes correlations between algorithms and logical groupings to provide category-specific data. The correlation and performance profiles represent a machine learning model that can be used to intelligently select algorithms to run for a given question.

The logical grouping uses intelligence techniques including machine learning models, such as, but not limited to, Logistical Regression. The classifiers or input for the machine learning models can include in one embodiment the features and performance metrics produced by the algorithms for a logical grouping.

Algorithm execution broker uses the machine learning model and the classification of the question and context in a logical grouping to determine which algorithms to run in real time. Based on the logical grouping and performance requirement, the algorithm execution broker dynamically controls which algorithms are run and the resources necessary using the machine learning model.

In accordance with one embodiment, training system A112 receives a preferences profile, which defines preferences of the HUD helmet processing system described herein. Preferences profile may define performance requirements, system resource restrictions, and desired accuracy of answers. Training system A112, more particularly algorithm execution broker, selects algorithms to use for a given set of images based on preferences profile, meeting the performance requirements and system resource utilization restrictions of the system.

The components of training system A112 work in tandem to allow for a more efficient and performance generalized gesture detection system. As the machine learning model is built and updated, the logical grouping of questions and context can be more defined and sub-categorized, which produces a better deep question and answering system.

Logical grouping component breaks the question down into key areas or groups based on the subject and the context domain. Logical grouping component uses any additional context information to conform and further group the question. For well-known or easy to identify gestures, these can be matched against predefined broad groups with smaller groups.

Learning controller and analyzer performs algorithm data capture, analyzes system performance, and performs logical grouping association. The algorithms identify themselves as they run and provide as output the feature set they are interested in. Learning controller and analyzer assigns a weight to each algorithm based on how much each feature affected the results. Weights may be on any unified scale, such as zero to one, zero to ten, or zero to one hundred. Each algorithm may have a unified application programming interface (API) to provide weight data. Algorithms provides as output how many features are added and which features are added or modified.

Learning controller and analyzer monitors heap size and memory pools. Learning controller and analyzer also captures start and end time for algorithm execution. Learning controller and analyzer also records the number of relevant features in the common analysis structure (CAS) and the number of CASes in the overall system. The common analysis structure in this embodiment can be generally substituted by a common data structure that is used within the overall system.

Logical grouping machine learning system captures the logical groupings that affect the analyzer and uses the captured groupings to make correlations between groupings and algorithms that contribute to accurate results. Based on these correlations, logical grouping machine learning system decides among multiple candidate groupings and multiple candidate sets of algorithms.

Algorithm execution broker selects a set of algorithms for a given question based on the feature types and features in a CAS and based on the influence level with which these features impact the algorithm. Algorithm execution broker applies the learning model to the incoming data and, if over a predetermined or dynamically determined threshold of influence, sets a given algorithm to execute.

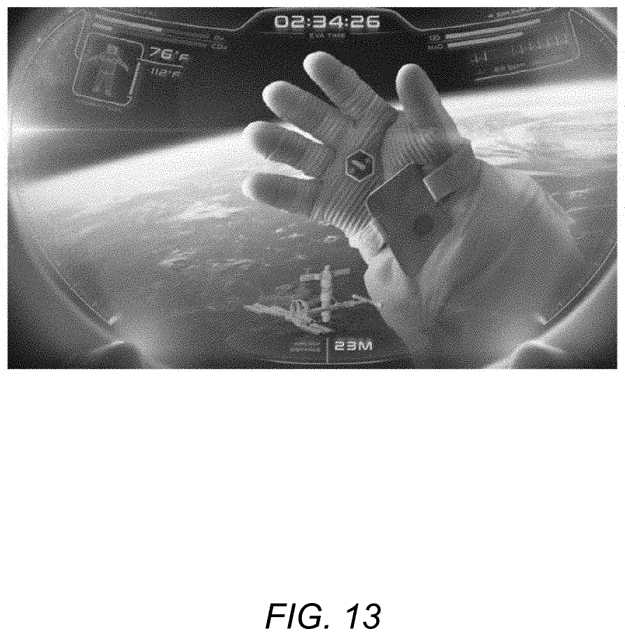

In one embodiment, a single embedded system is comprised of a heads-up display that is disposed within a helmet. The heads-up display A104 displays information in response to the identification of hand or arm based gestures. Specifically, the display A104 displays information on-demand, without having to always display information on the display A104. This feature permits an astronaut to perform tasks with high visibility of the environment around him or her. The present system only temporarily partially occludes the astronaut's vision. An exemplary system for displaying data on a display A104, in accordance with an embodiment, is illustrated in FIG. 13.

The network A110 connects the various systems and computing devices described or referenced herein. In particular embodiments, network A110 is an intranet, an extranet, a virtual private network (VPN), a local area network (LAN), a wireless LAN (WLAN), a wide area network (WAN), a metropolitan area network (MAN), a portion of the Internet, or another network A110 or a combination of two or more such networks A110. The present disclosure contemplates any suitable network A110.

One or more links couple one or more systems, engines or devices to the network A110. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network A110.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers.

In particular embodiments, the helmet A102 (also referred to as a user device herein) may be an electronic device including hardware, software, or embedded logic components or a combination of two or more such components and capable of carrying out the appropriate functions implemented or supported by the helmet A102. The helmet A102 may also include an application that is loaded onto the device.

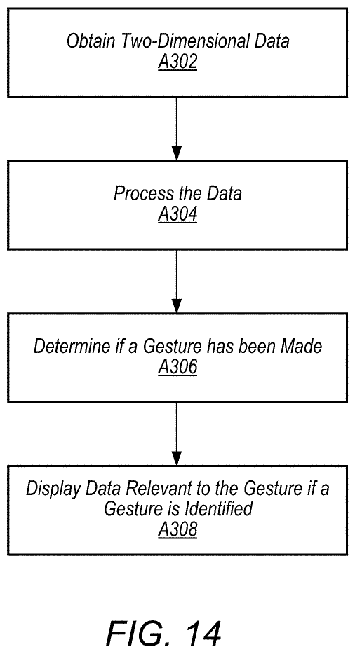

FIG. 14 illustrates an embodiment of the process steps for displaying on-demand information on the heads-up display of a helmet. The process is comprised of obtaining A302 two-dimensional data from one or more image capture devices. Processing the data A304 based on training data, and determining A306 whether a gesture has been made. Displaying A308 relevant data on a display responsive to detection of a gesture. In one embodiment, wherein the display is turned off when one or more gestures are not detected.

What is claimed is:

1. An apparatus, comprising:
a wearable element configured to be worn by a user;
a sensor array coupled to the wearable element, wherein the sensor array includes at least one image capture element directed towards a field of view of a user wearing the wearable element;
a display screen positioned in the wearable element, wherein the display screen is positioned to cover the field of view of the user when the user wears the wearable element; and
a processor unit configured to receive data from the sensor array and to receive data from at least one data source in wireless communication with the processor unit;
wherein the processor unit is configured to generate a head-up display for display on the display screen, the head-up display corresponding to the user's field of view, and wherein the head-up display is generated using data received from the at least one image capture element in combination with data received from the at least one data source in wireless communication with the processor unit.

2. The apparatus of claim 1, wherein the wearable element is a helmet.

3. The apparatus of claim 1, wherein the at least one image capture element includes one or more of the following: an optical camera, a night vision camera, an infrared vision camera, and a thermal imaging camera.

4. The apparatus of claim 1, wherein the head-up display replaces the field of view of the user during use of the wearable element.

5. The apparatus of claim 1, wherein the head-up display displays data that identifies at least one object in the user's field of view, the at least one object being detected using the sensor array.

6. The apparatus of claim 1, wherein the head-up display displays data that indicates a position of one or more users wearing additional apparatus that are in communication with the apparatus.

7. The apparatus of claim 1, wherein the head-up display is displayed on the display screen according to a plurality of display modes.

8. The apparatus of claim 7, wherein the plurality of display modes includes one or more of the following modes: day vision, thermal vision, night vision, and infrared vision.

9. The apparatus of claim 7, wherein the apparatus is configured to switch between the plurality of display modes in response to at least one of user gestures and user voice commands.

10. A method, comprising:
receiving, at a computer processor coupled to a wearable element worn by a user, data from a sensor array coupled to the wearable element, wherein data from the sensor array includes data captured by at least one image capture element directed towards a field of view of the user wearing the wearable element;
receiving, at the computer processor, data from at least one data source in wireless communication with the computer processor;
generating, at the computer processor, a head-up display using data received from the at least one image capture element in combination with data received from the at least one data source in wireless communication with the computer processor, wherein the head-up display corresponds to the user's field of view; and
displaying, on a display screen positioned in the wearable element, the head-up display, wherein the display screen is positioned to cover the field of view of the user when the user wears the wearable element.

11. The method of claim 10, wherein data from the sensor array includes data from one or more of the following sensors: environmental sensors, global positioning system sensors, and biometric sensors.

12. The method of claim 10, wherein the wearable element is a helmet.

13. The method of claim 10, wherein the data captured by at least one image capture element includes one or more of the following types of data: data from an optical camera, data from a night vision camera, data from an infrared vision camera, and data from a thermal imaging camera.

14. The method of claim 10, wherein displaying the head-up display includes replacing the field of view of the user of the wearable element.

15. An apparatus, comprising:
a wearable element configured to be worn by a user, wherein the wearable element includes a display screen that covers a field of view of the user during use;
a sensor array that includes at least one image capture element directed toward the field of view of the user during use; and
a processor unit configured to receive sensor data from the at least one image capture element and use the sensor data to generate, on the display screen according to a plurality of display modes, a head-up display corresponding to the user's field of view;
wherein the apparatus is configured to switch between the plurality of display modes in response to user commands.

16. The apparatus of claim 15, wherein the wearable element is a helmet.

17. The apparatus of claim 15, wherein the at least one image capture element includes one or more of the following: an optical camera, a night vision camera, an infrared vision camera, and a thermal imaging camera.

18. The apparatus of claim 15, wherein the sensor array includes one or more of the following sensors: environmental sensors, global positioning system sensors, and biometric sensors.

19. The apparatus of claim 15, wherein the plurality of display modes includes one or more of the following modes: day vision, thermal vision, night vision, and infrared vision.

20. The apparatus of claim 15, wherein the head-up display displays data that identifies at least one object in the user's field of view, the at least one object being detected using the sensor array.
